(19) United States
(12) Patent Application Publication
(10) Pub. No.: US 2006/0043896 A1
(43) Pub. Date: Mar. 2, 2006

(54) Plasma display apparatus including barrier rib and method of manufacturing the same

(76) Inventor: Jin Hee Jeong, Seongnam-si (KR)

Correspondence Address: MCKENNA LONG & ALDRIDGE LLP, 1900 K STREET, NW, WASHINGTON, DC, 20006, US

(21) Appl. No.: 11/214,777

(22) Filed: Aug. 31, 2005

(30) Foreign Application Priority Data
Sep. 2, 2004 (KR) 10-2004-0070111

(51) Int. Cl. H01J 17/49; H01J 9/00

(52) U.S. Cl. 313/587; 313/582; 313/586; 445/24

(57) ABSTRACT

The present invention relates to a plasma display apparatus and method of manufacturing the same, wherein the amount of electric charges charged on barrier ribs can be reduced. According to the present invention, the method of manufacturing the plasma display apparatus includes the steps of forming barrier ribs on a rear glass substrate; and forming a charging-prevention layer on the barrier ribs, the charging-prevention layer having a dielectric constant lower than that of a dielectric constant of the barrier ribs. The present invention includes a charging-prevention layer. Accordingly, Since the amount of electric charges charged on barrier ribs is reduced, generation of erroneous discharge can be prevented and a jitter characteristic can be improved.

### CROSS-REFERENCE TO RELATED APPLICATIONS

This Nonprovisional application claims priority under 35 U.S.C. § 119(a) on patent application No. 2004-0070111 filed in Korea on Sep. 2, 2004 the entire contents of which are hereby incorporated by reference.

### BACKGROUND OF THE INVENTION

1. Field of the Invention

The present invention relates to a plasma display apparatus and method of manufacturing the same, and more particularly, to a plasma display apparatus having barrier ribs and method of manufacturing the same.

2. Background of the Related Art

A typical plasma display apparatus displays images using a gas discharge generating between electrodes to which an AC voltage or a DC voltage is applied. That is, irradiation of UV rays is generated by gas discharge. Phosphors are emitted by means of irradiation of UV rays. The common plasma display apparatus displays images through emission of phosphors.

FIG. 1 is a perspective view schematically showing the construction of a conventional plasma display apparatus.

As shown in FIG. 1, the conventional plasma display apparatus includes a front glass substrate 10 and a rear glass substrate 20. The front glass substrate 10 is a display surface on which images are displayed. The rear glass substrate 20 is parallel to the front glass substrate 10 with a predetermined distance therebetween.

The front glass substrate 10 includes a scan electrode 11 and a sustain electrode 12 for sustaining sustain discharge. The scan electrode 11 and the sustain electrode 12 form wall charges and sustain discharging by means of a discharge sustain voltage. Each of the scan electrode 11 and the sustain electrode 12 has transparent electrodes 11a,12a and bus electrodes 11b,12b. The transparent electrodes 11a,12a are formed using a transparent Indium Thin Oxide (ITO) material. The bus electrodes 11b,12b are made of a metal material.

The upper dielectric layer 13a protects the scan electrode 11 and the sustain electrode 12 from impact incurred by the movement of ions upon plasma discharge, and serves as an anti-diffusion film.

The protection layer 14 is formed on the upper dielectric layer 13a and facilitates emission of secondary electrons. The protection layer 14 is formed by deposition of magnesium oxide (MgO).

The barrier ribs 21 form cells, and are arranged in parallel to each other on the rear glass substrate 20.

The address electrodes 22 are formed on the rear glass substrate 20 in a direction parallel to the barrier ribs 21. They perform an address discharge at the intersection of the scan electrode 11 and the sustain electrode 12.

The lower dielectric layer 13b is formed on the address electrodes 22. R, G and B phosphor layers 23 are coated between the barrier ribs 21 and emit a visible ray for displaying images.

The front glass substrate 10 and the rear glass substrate 20 are adhered together through plasticity of frit glass. They then experience an exhaust process for removing impurities within the plasma display apparatus. After the exhaust process, an inert gas such as helium (He), neon (Ne) or xenon (Xe) is injected into the plasma display apparatus so as to improve emission efficiency.

FIG. 2 shows the structure of barrier ribs of the conventional plasma display apparatus.

As shown in FIG. 2, the address electrodes 22 and the dielectric layer 13b are formed on the rear glass substrate 20. The barrier ribs 21 are formed on the dielectric layer 13b. The R, G and B phosphor layers 23 are coated between the barrier ribs 21.

A method of forming barrier ribs of the plasma display apparatus can include a printing method, a sandblast method, a direct etching method and the like. Of them, the direct etching method is mainly used. The direct etching method consists of coating, exposure, development and etching processes of a photoresist. A barrier rib formation material is coated on the dielectric layer 13b and then dried. A photoresist is formed on the barrier rib formation material. The photoresist is exposed to UV rays through a mask. A pattern is formed through a development process and the barrier ribs 21 are then formed through an etching process. Thereafter, the barrier ribs 21 are located in a furnace for baking. After the barrier ribs 21 are formed, the phosphor layers 23 are formed between the barrier ribs 21.

The conventional barrier ribs 21 formed through this process has a high dielectric constant. The dielectric constant of the conventional barrier ribs 21 is approximately 12. The barrier ribs 21 are formed of SiO₂, MgO, ZnO, BaO, PbO or the like. The main cause to increase the dielectric constant of the barrier ribs 21 is PbO.

Accordingly, when an address discharge is generated, electric charges charged on the barrier ribs 21 become much, whereas electric charges existing in the discharge spaces of the cells become less. If electric charges existing in the discharge spaces of the cells become less, an addressing discharge is not completely generated. Accordingly, there are problems in that erroneous discharge is generated and a jitter characteristic is degraded.

### SUMMARY OF THE INVENTION

Accordingly, the present invention has been made in view of the above problems occurring in the prior art, and it is an object of the present invention to provide a plasma display apparatus and method of manufacturing the same, wherein the amount of electric charges charged on barrier ribs can be reduced.

A method of manufacturing a plasma display apparatus according to the present invention includes the steps of forming barrier ribs on a rear glass substrate; and forming a charging-prevention layer on the barrier ribs, the charging-prevention layer having a dielectric constant lower than that of a dielectric constant of the barrier ribs.

The dielectric constant of the charging-prevention layer may range from more than 1 to less than 12.

The charging-prevention layer may have a thickness of 1 μm to 3 μm.

The charging-prevention layer may contain PbO, and the content of PbO contained in the charging-prevention layer can be smaller than that of PbO contained in the barrier ribs.

The charging-prevention layer may be formed by either etching or screen-printing.

The charging-prevention layer may contain a black dye.

The charging-prevention layer may contain iron oxide or/and chrome oxide.

A method of manufacturing a plasma display apparatus according to the present invention includes the steps of forming barrier ribs on a rear glass substrate, and forming a charging-prevention layer on the barrier ribs, the charging-prevention layer having a dielectric constant lower than that of the barrier ribs and containing a black dye.

The charging-prevention layer may contain iron oxide or/and chrome oxide.

The dielectric constant of the charging-prevention layer may range a range from more than 1 to less than 12.

The charging-prevention layer may have a thickness of 1 μm to 3 μm.

The charging-prevention layer can contain PbO, and the content of PbO contained in the charging-prevention layer may be smaller than that of PbO contained in the barrier ribs.

A plasma display apparatus according to the present invention includes barrier ribs forming cells, and a charging-prevention layer formed on the barrier ribs, the charging-prevention layer having a dielectric constant lower than that of the barrier ribs.

The dielectric constant of the charging-prevention layer may range from more than 1 to less than 12.

The charging-prevention layer may have a thickness of 1 μm to 3 μm.

The charging-prevention layer can contain PbO, and the amount of PbO contained in the charging-prevention layer may be smaller than the amount of PbO contained in the barrier ribs.

The charging-prevention layer may contain a black dye.

The charging-prevention layer may contain iron oxide or/and chrome oxide.

### BRIEF DESCRIPTION OF THE DRAWINGS

Further objects and advantages of the invention can be more fully understood from the following detailed description taken in conjunction with the accompanying drawings in which:

FIG. 1 is a perspective view schematically showing the construction of a conventional plasma display apparatus;

FIG. 2 shows the structure of barrier ribs of the conventional plasma display apparatus;

FIGS. 3a to 3e show a process of forming a charging-prevention layer of the plasma display apparatus according to an etching method according to a first embodiment of the present invention;

FIGS. 4a to 4d show a process of forming a charging-prevention layer of the plasma display apparatus according to a screen printing method according to a first embodiment of the present invention;

FIGS. 5a to 5e show a process of forming a charging-prevention layer of the plasma display apparatus according to an etching method according to a second embodiment of the present invention; and

FIGS. 6a to 6d show a process of forming a charging-prevention layer of the plasma display apparatus according to a screen-printing method according to a second embodiment of the present invention.

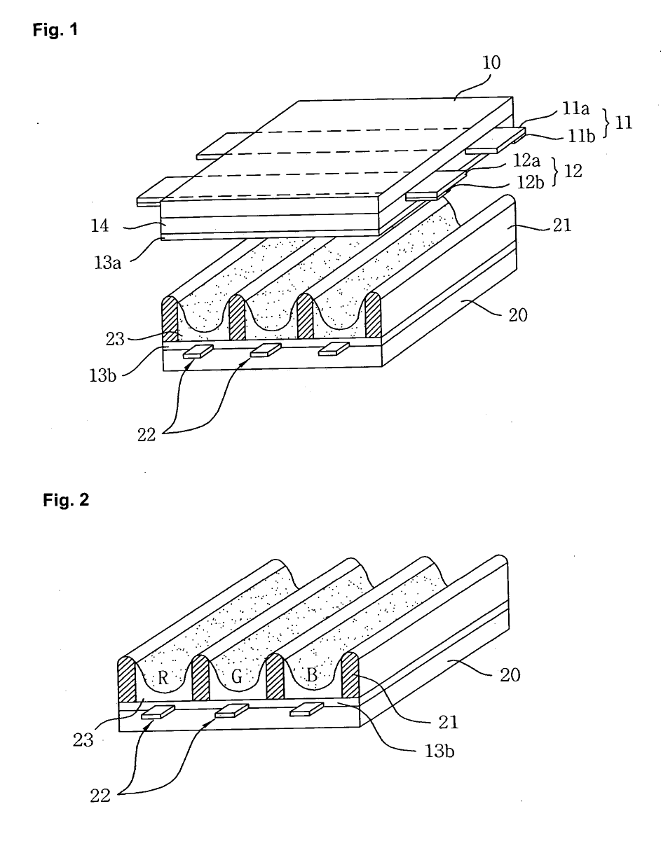

### DETAILED DESCRIPTION OF THE PREFERRED EMBODIMENT

The present invention will now be described in detail in connection with preferred embodiments with reference to the accompanying drawings.

### Embodiment 1

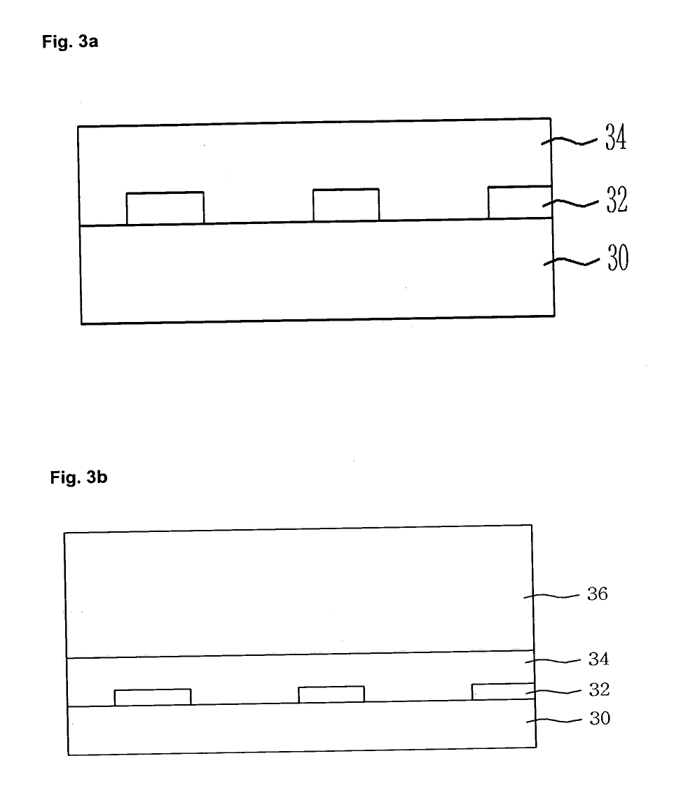

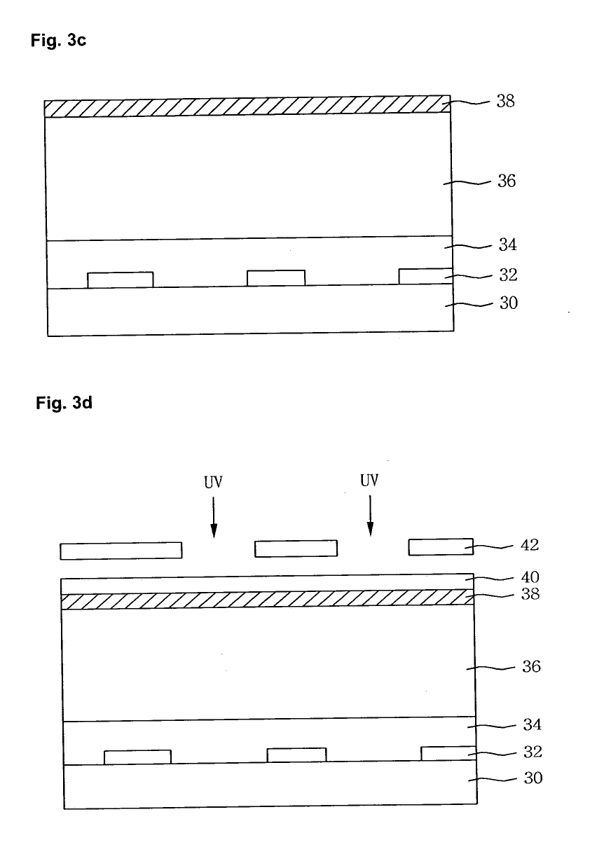

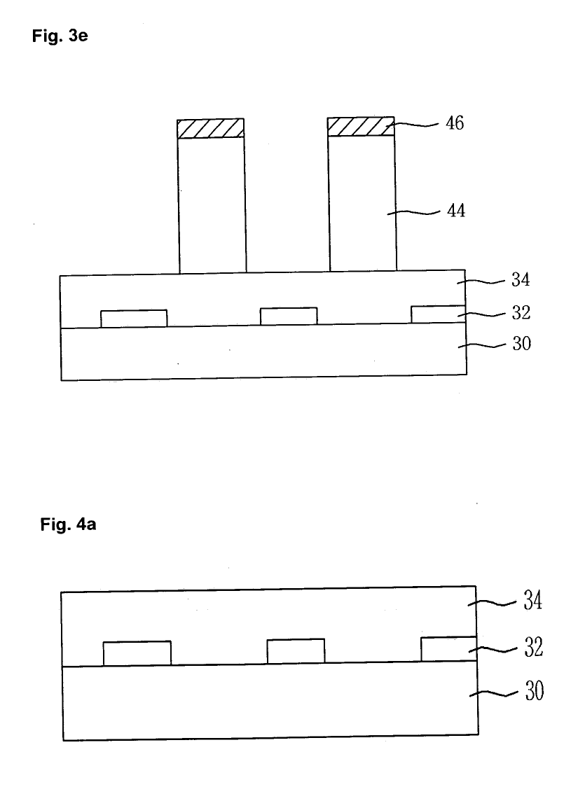

FIGS. 3a to 3e show a process of forming a charging-prevention layer of the plasma display apparatus according to an etching method according to a first embodiment of the present invention.

Referring to FIG. 3a, a rear glass substrate 30 in which address electrodes 32 and a dielectric layer 34 are formed is prepared.

Referring to FIG. 3b, a barrier rib material 36 for forming barrier ribs is coated on the dielectric layer 34 and then dried. The barrier rib material 36 reduces the amount of electric charges existing in discharge spaces of cells upon address discharge since it has a high dielectric constant. Accordingly, erroneous discharge is generated and a jitter characteristic is degraded.

Referring to FIG. 3c, a charging-prevention layer material 38 is coated on the barrier rib material 36. A dielectric constant of the charging-prevention layer material 38 is lower than that of the barrier rib material 36. The dielectric constant of the charging-prevention layer material 38 can range from more than 1 to less than 12.

Referring to FIG. 3d, a photoresist 40 is coated on the charging-prevention layer material 38. The photoresist 40 is exposed to UV rays through a photo mask 42. The photo mask 42 has the same pattern as the barrier ribs.

Referring to FIG. 3e, if a development process is performed on the exposed photoresist 40, a pattern of the barrier ribs is formed in the photoresist 40. Barrier ribs 44 are then formed through an etch process. A charging-prevention layer 46 is formed on the barrier ribs 44. At this time, the charging-prevention layer 46 has a thickness of 1 μm to 3 μm. Furthermore, the charging-prevention layer 46 can be formed using SiO₂, MgO, ZnO, BaO, PbO or the like. In this case, the content of PbO contained in the charging-prevention layer 46 is smaller than that contained in the barrier ribs 44. Therefore, a dielectric constant of the charging-prevention layer 46 is lower than that of the barrier ribs 44. The dielectric constant of the charging-prevention layer 46 can be controlled to range from more than 1 to less than 12 depending on the content of PbO.

The dielectric constant of the charging-prevention layer 46 is lower than that of the conventional barrier ribs 21. Thus, the amount of electric charges charged on the barrier ribs 21 is reduced. As described above, if the charging-prevention layer 46 having a lower dielectric constant than that of the barrier rib material 36 is formed on the barrier ribs 44, it is possible to prevent electric charges from being charged on the barrier ribs 21 upon address discharge. Accordingly, charges existing in discharge spaces of cells become much and addressing discharge is completely generated. It is thus possible to prevent generation of erroneous discharge and to improve a jitter characteristic.

As described above, the charging-prevention layer 46 formed on the barrier ribs 44 according to the first embodiment can also be formed by the screen-printing method.

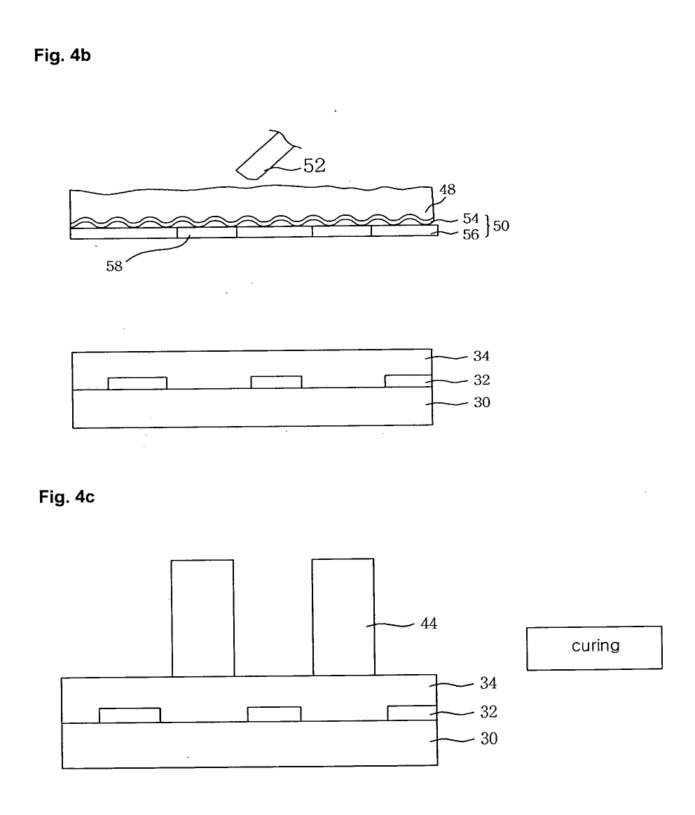

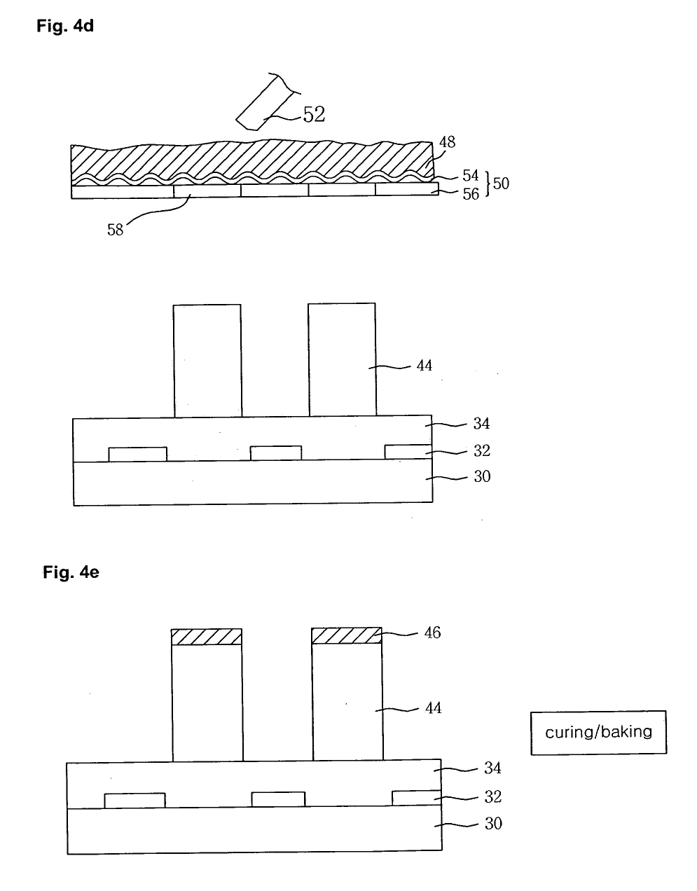

FIGS. 4a to 4d show a process of forming a charging-prevention layer of the plasma display apparatus according to the screen-printing method according to a first embodiment of the present invention.

Referring to FIG. 4a, a rear glass substrate 30 in which address electrodes 32 and a dielectric layer 34 are formed is prepared.

As shown in FIG. 4b, if a barrier rib material paste 48 for forming barrier ribs is coated on a screen mask 50, a squeeze 52 pushes the barrier rib material paste 48 down. The screen mask 50 consists of a mesh net 54 generally made of metal, and a pattern formation layer 56 in which a pattern of barrier ribs is formed. As described above, if the squeeze 52 pushes the barrier rib material paste 48 down, the barrier rib material paste 48 moves through a hole 58 of the pattern formation layer 56.

Referring to FIG. 4c, if the barrier rib material paste 48 moves through the hole 58 of the pattern formation layer 56, barrier ribs 44 are formed. Thereafter, the barrier ribs 44 are cured by heating at a predetermined temperature.

As shown in FIG. 4d, a charging-prevention paste 60 for forming a charging-prevention layer is coated on the screen mask 50. The squeeze 52 pushes the charging-prevention paste 60 downwardly. As described above, if the squeeze 52 pushes the charging-prevention paste 60 downwardly, the charging-prevention paste 60 moves through the hole 58 of the pattern formation layer 56.

Referring to FIG. 4e, if the charging-prevention paste 60 moves through the hole 58 of the pattern formation layer 56, a charging-prevention layer 46 is formed. Thereafter, the charging-prevention layer 46 is cured by heating at a predetermined temperature. A baking process is then performed on the barrier ribs 44 and the charging-prevention layer 46.

At this time, a thickness of the charging-prevention layer 46 ranges from 1 μm to 3 μm. Furthermore, the charging-prevention layer 46 is formed using SiO₂, MgO, ZnO, BaO, PbO or the like. In this case, the content of PbO contained in the charging-prevention layer 46 is smaller than that contained in the barrier ribs 44. Therefore, a dielectric constant of the charging-prevention layer 46 is lower than that of the barrier ribs 44. The dielectric constant of the charging-prevention layer 46 can be controlled to range from more than 1 to less than 12 depending on the content of PbO.

The dielectric constant of the charging-prevention layer 46 is lower than that of the conventional barrier ribs 21. Thus, the amount of electric charges charged on the barrier ribs 21 is reduced. As described above, if the charging-prevention layer 46 having a lower dielectric constant than that of the barrier rib material 36 is formed on the barrier ribs 44, it is possible to prevent electric charges from being charged on the barrier ribs 21 upon address discharge. Accordingly, charges existing in discharge spaces of cells are increased and addressing discharge is completely generated. It is thus possible to prevent generation of erroneous discharge and to improve a jitter characteristic.

### Embodiment 2

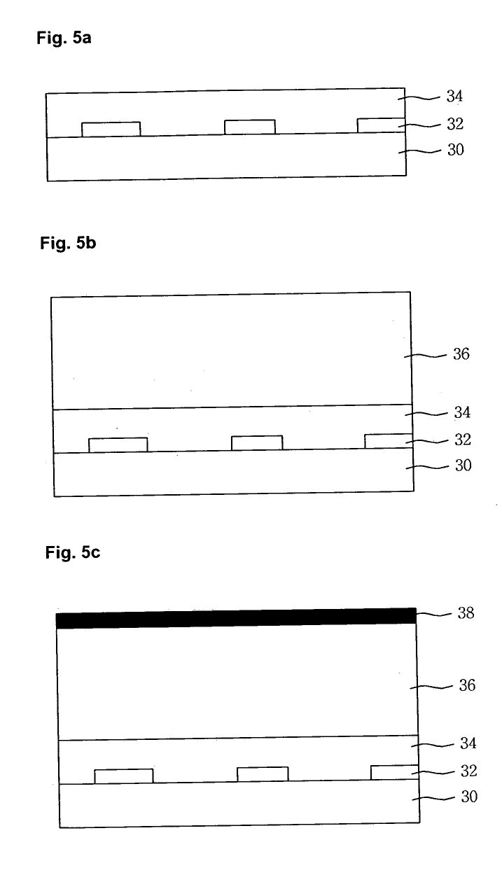

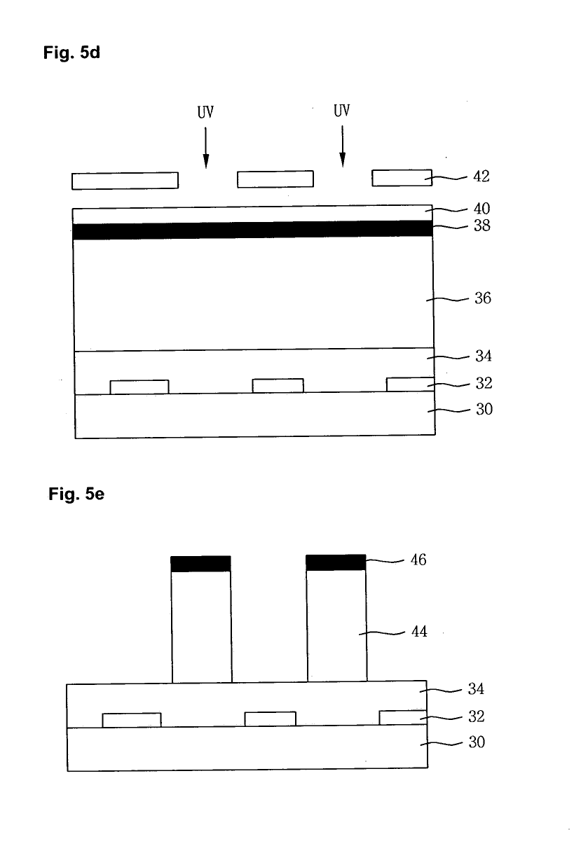

FIGS. 5a to 5e show a process of forming a charging-prevention layer of the plasma display apparatus according to an etching method according to a second embodiment of the present invention.

Referring to FIG. 5a, a rear glass substrate 30 in which address electrodes 32 and a dielectric layer 34 are formed is prepared.

Referring to FIG. 5b, a barrier rib material 36 for forming barrier ribs is coated on the dielectric layer 34 and then dried. The barrier rib material 36 reduces the amount of electric charges existing in discharge spaces of cells upon address discharge since it has a high dielectric constant. Accordingly, erroneous discharge is generated and a jitter characteristic is degraded.

Referring to FIG. 5c, a charging-prevention layer material 38 is coated on the barrier rib material 36. A dielectric constant of the charging-prevention layer material 38 is lower than that of the barrier rib material 36. The dielectric constant of the charging-prevention layer material 38 can range from more than 1 to less than 12. Furthermore, the charging-prevention layer material 36 contains a black dye such as iron oxide or chrome oxide. Accordingly, the color of the charging-prevention layer material 36 used in the second embodiment of the present invention is black.

Referring to FIG. 5d, a photoresist 40 is coated on the charging-prevention layer material 38. The photoresist 40 is exposed to UV rays through a photo mask 42. The photo mask 42 has the same pattern as the barrier ribs.

Referring to FIG. 5e, if a development process is performed on the exposed photoresist 40, a pattern of the barrier ribs is formed in the photoresist 40. Barrier ribs 44 are then formed by etching. A charging-prevention layer 46 is formed on the barrier ribs 44. At this time, the charging-prevention layer 46 has a thickness of 1 μm to 3 μm.

Furthermore, the charging-prevention layer 46 can be formed using SiO₂, MgO, ZnO, BaO, PbO or the like. In this case, the content of PbO contained in the charging-prevention layer 46 is smaller than that contained in the barrier ribs 44. Therefore, a dielectric constant of the charging-prevention layer 46 is lower than that of the barrier ribs 44. The dielectric constant of the charging-prevention layer 46 can be controlled to range from more than 1 to less than 12 depending on the content of PbO.

Furthermore, the charging-prevention layer 46 also serves as a black matrix. That is, the charging-prevention layer 46 of the present invention is formed through the charging-prevention layer 46 containing a black dye such as iron oxide or chrome oxide. Thus, the color of the charging-prevention layer 46 is black.

The dielectric constant of the charging-prevention layer 46 is lower than that of the conventional barrier ribs 21. Thus, the amount of electric charges charged on the barrier ribs 21 is reduced. As described above, if the charging-prevention layer 46 having a lower dielectric constant than that of the barrier rib material 36 is formed on the barrier ribs 44, it is possible to prevent electric charges from being charged on the barrier ribs 21 upon address discharge. Accordingly, charges existing in discharge spaces of cells are increased and addressing discharge is completely generated. It is thus possible to prevent generation of erroneous discharge and to improve a jitter characteristic. Furthermore, the charging-prevention layer 46 according to a second embodiment of the present invention contains a black dye and thus serves as a black matrix.

As described above, the charging-prevention layer 46 formed on the barrier ribs 44 according to the second embodiment can also be formed by the screen-printing method.

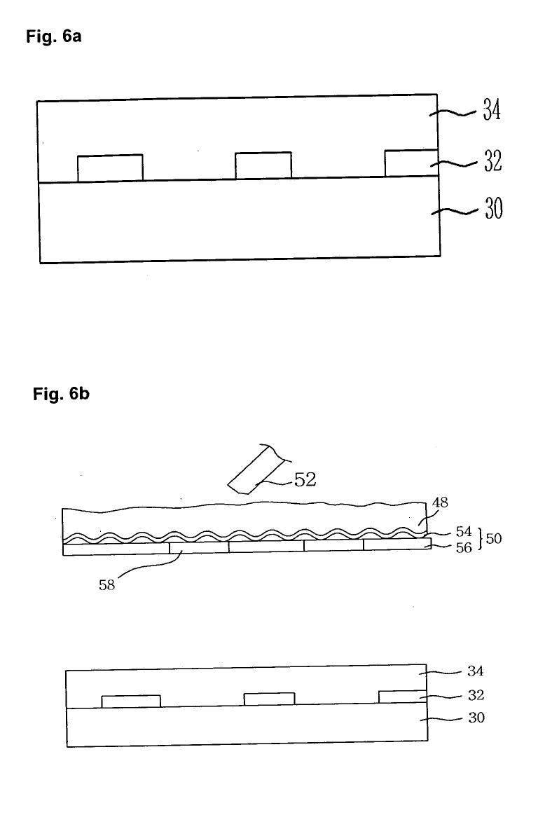

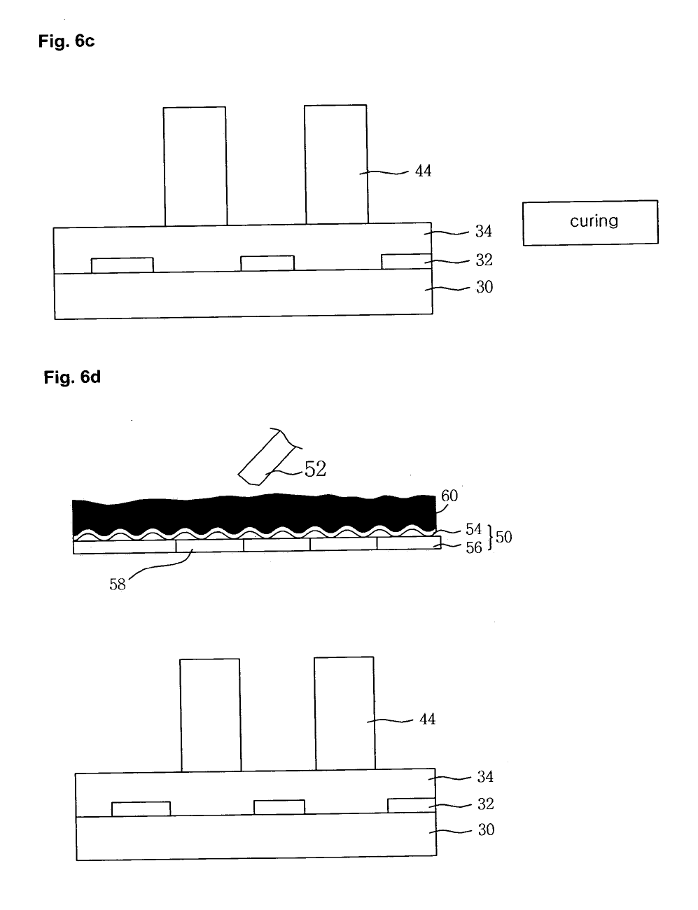

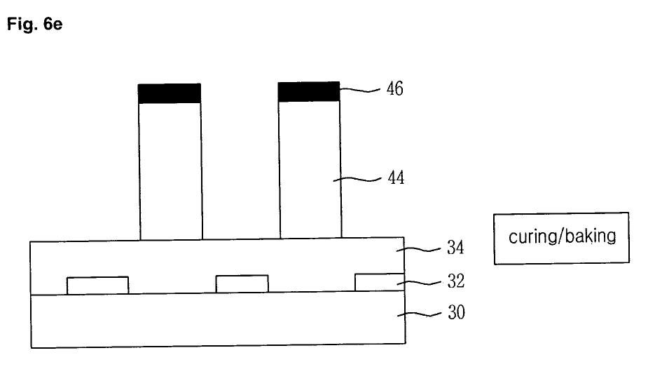

FIGS. 6a to 6d show a process of forming a charging-prevention layer of the plasma display apparatus according to a screen-printing method according to the second embodiment of the present invention.

Referring to FIG. 6a, a rear glass substrate 30 in which address electrodes 32 and a dielectric layer 34 are formed is prepared.

As shown in FIG. 6b, if a barrier rib material paste 48 for forming barrier ribs is coated on a screen mask 50, a squeeze 52 pushes the barrier rib material paste 48 down. The screen mask 50 consists of a mesh net 54 generally made of metal, and a pattern formation layer 56 in which a pattern of barrier ribs is formed. As described above, if the squeeze 52 pushes the barrier rib material paste 48 downwardly, the barrier rib material paste 48 moves through a hole 58 of the pattern formation layer 56.

Referring to FIG. 6c, if the barrier rib material paste 48 moves through the hole 58 of the pattern formation layer 56, barrier ribs 44 are formed. Thereafter, the barrier ribs 44 are cured by heating at a predetermined temperature.

As shown in FIG. 6d, a charging-prevention paste 60 for forming a charging-prevention layer is coated on the screen mask 50. At this time, the charging-prevention layer material 36 contains a black dye such as iron oxide or chrome oxide. Accordingly, the color of the charging-prevention layer material 36 used in the second embodiment of the present invention is black. The squeeze 52 pushes the charging-prevention paste 60 down. As described above, if the squeeze 52 pushes the charging-prevention paste 60 downwardly, the charging-prevention paste 60 moves through the hole 58 of the pattern formation layer 56.

Referring to FIG. 6e, if the charging-prevention paste 60 moves through the hole 58 of the pattern formation layer 56, a charging-prevention layer 46 is formed. Thereafter, the charging-prevention layer 46 is cured by heating at a predetermined temperature. A baking process is then performed on the barrier ribs 44 and the charging-prevention layer 46.

At this time, a thickness of the charging-prevention layer 46 ranges from 1 μm to 3 μm. Furthermore, the charging-prevention layer 46 is formed using SiO₂, MgO, ZnO, BaO, PbO or the like. In this case, the content of PbO contained in the charging-prevention layer 46 is smaller than that contained in the barrier ribs 44. Therefore, a dielectric constant of the charging-prevention layer 46 is lower than that of the barrier ribs 44. The dielectric constant of the charging-prevention layer 46 can be controlled to range from 1 to less than 12 depending on the content of PbO.

Furthermore, the charging-prevention layer 46 also serves as a black matrix. That is, the charging-prevention layer 46 of the present invention is formed through the charging-prevention layer 46 containing a black dye such as iron oxide or chrome oxide. Thus, the color of the charging-prevention layer 46 is black.

The dielectric constant of the charging-prevention layer 46 is lower than that of the conventional barrier ribs 21. Thus, the amount of electric charges charged on the barrier ribs 21 is reduced. As described above, if the charging-prevention layer 46 having a lower dielectric constant than that of the barrier rib material 36 is formed on the barrier ribs 44, it is possible to prevent electric charges from being charged on the barrier ribs 21 upon address discharge. Accordingly, charges existing in discharge spaces of cells are increased and addressing discharge is completely generated. It is thus possible to prevent generation of erroneous discharge and to improve a jitter characteristic. Furthermore, the charging-prevention layer 46 according to a second embodiment of the present invention contains a black dye and thus serves as a black matrix.

The present invention includes a charging-prevention layer. Thus, the amount of electric charges charged on barrier ribs can be reduced.

The present invention includes a charging-prevention layer. Thus, the amount of electric charges charged on barrier ribs is reduced. Accordingly, generation of erroneous discharge can be prevented.

The present invention includes a charging-prevention layer. Thus, the amount of electric charges charged on barrier ribs is reduced. Accordingly, a jitter characteristic can be improved.

The present invention includes a charging-prevention layer containing a black dye. Accordingly, the charging-prevention layer can serve as a black matrix while the amount of electric charges charged on barrier ribs is reduced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of manufacturing a plasma display apparatus, comprising the steps of:
forming barrier ribs on a rear glass substrate; and
forming a charging-prevention layer on the barrier ribs, the charging-prevention layer having a dielectric constant lower than that of a dielectric constant of the barrier ribs.

2. The method as claimed in claim 1, wherein the dielectric constant of the charging-prevention layer ranges from more than 1 to less than 12.

3. The method as claimed in claim 1, wherein the charging-prevention layer has a thickness of 1 μm to 3 μm.

4. The method as claimed in claim 1, wherein the charging-prevention layer contains PbO, and the content of PbO contained in the charging-prevention layer is smaller than that of PbO contained in the barrier ribs.

5. The method as claimed in claim 1, wherein the charging-prevention layer is formed by either etching or screen printing.

6. The method as claimed in claim 1, wherein the charging-prevention layer contains a black dye.

7. The method as claimed in claim 6, wherein the charging-prevention layer contains iron oxide or/and chrome oxide.

8. A method of manufacturing a plasma display apparatus, comprising the steps of:
forming barrier ribs on a rear glass substrate; and
forming a charging-prevention layer on the barrier ribs, the charging-prevention layer having a dielectric constant lower than that of the barrier ribs and containing a black dye.

9. The method as claimed in claim 8, wherein the charging-prevention layer contains iron oxide or/and chrome oxide.

10. The method as claimed in claim 8, wherein the dielectric constant of the charging-prevention layer ranges from more than 1 to less than 12.

11. The method as claimed in claim 8, wherein the charging-prevention layer has a thickness of 1 μm to 3 μm.

12. The method as claimed in claim 8, wherein the charging-prevention layer contains PbO, and the content of PbO contained in the charging-prevention layer is smaller than that of PbO contained in the barrier ribs.

13. A plasma display apparatus, comprising:
barrier ribs for forming cells; and
a charging-prevention layer formed on the barrier ribs, the charging-prevention layer having a dielectric constant lower than that of the barrier ribs.

14. The plasma display apparatus claimed in claim 13, wherein the dielectric constant of the charging-prevention layer ranges from more than 1 to less than 12.

15. The plasma display apparatus as claimed in claim 13, wherein the charging-prevention layer has a thickness of 1 μm to 3 μm.

16. The plasma display apparatus as claimed in claim 13, wherein the charging-prevention layer contains PbO, and the content of PbO contained in the charging-prevention layer is smaller than the content of PbO contained in the barrier ribs.

17. The plasma display apparatus as claimed in claim 13, wherein the charging-prevention layer contains a black dye.

18. The plasma display apparatus as claimed in claim 17, wherein the charging-prevention layer contains iron oxide or/and chrome oxide.
